(19) United States
(12) Patent Application Publication
(10) Pub. No.: US 2021/0097862 A1
(43) Pub. Date: Apr. 1, 2021

(54) DYNAMIC AUCTIONS FOR PICK-UP AND DROP-OFF LOCATIONS

(71) Applicant: GM CRUISE HOLDINGS LLC, San Francisco, CA (US)

(72) Inventors: Stephanie Olivia Engle, San Francisco, CA (US); Soleil Phan, San Francisco, CA (US); Jacqueline Shannon, Corte Madera, CA (US); Jessica Leary, San Francisco, CA (US)

(21) Appl. No.: 16/589,072

(22) Filed: Sep. 30, 2019

(51) Int. Cl. G08G 1/14; G06Q 10/02; G06Q 30/08; G05D 1/02

(52) U.S. Cl. CPC G08G 1/149; G06Q 10/02; G05D 2201/0213; G05D 1/0225; G08G 1/142; G06Q 30/08

(57) ABSTRACT

A non-transitory computer readable medium comprising instructions that when executed causes at least one processor to identify a parking space and submit a bid on the parking space. The parking space may be at a first location from a dynamic database listing available parking spaces in an area. The bid, if accepted, will reserve the parking space. The bid may be calculated using common criteria shared by an autonomous vehicle and other autonomous vehicles bidding for the parking space.

### TECHNICAL FIELD

The present technology relates to allocating pick-up and drop-off locations and more particularly to dynamically allocating pick-up and drop-off locations to autonomous vehicles.

### BACKGROUND

An autonomous vehicle is a motorized vehicle that can navigate without a human driver. An exemplary autonomous vehicle includes a plurality of sensor systems, such as, but not limited to, a camera sensor system, a lidar sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system.

In a ridesharing context, a vehicle will often need to park in a parking space to either drop-off or pick-up a passenger. While human drivers may use their judgment to take parking spaces to drop-off or pick-up the passenger, it is challenging for autonomous vehicles to do so. Furthermore, the usage of these parking spaces are on a first come, first serve basis, which may be inefficient especially when the area is heavily congested.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 shows an example of a content management system and client devices;

FIG. 2 shows an example environment of autonomous vehicles communicating for a pick-up or drop-off location;

FIG. 3 is a flow diagram that illustrates an example process for dynamically allocating a pick-up or drop-off location; and

FIG. 4 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form in order to facilitate describing one or more aspects. Further, it is to be understood that functionality that is described as being carried out by certain system components may be performed by more or fewer components than shown.

In general, a ridesharing vehicle will need to drop-off or pick-up a passenger using a parking space. Despite human drivers using their judgment to park in parking spaces to drop-off or pick-up passengers, the usage of these spaces is typically inefficient because the first come, first serve basis of these parking spaces cause congestion. Similarly, it is challenging for autonomous vehicles to determine when and where to pick-up or drop-off passengers.

Furthermore, the vehicles that do not get the space may, in many instances, more efficiently use the parking space. For example, in a heavily congest area, the parking space may be used by a first vehicle having a first passenger that quickly enters and/or exits the first vehicle, but the first vehicle may be prevented from leaving the parking space because a second vehicle is double parked next to the first vehicle and the second vehicle has a second passenger that enters and/or exits the second vehicle slowly. Thus, there is congestion because the second vehicle is blocking the first vehicle from leaving. In other words, even for vehicles having human drivers, the usage and efficiency of the parking spaces is heavily impacted.

Accordingly, the disclosed technology addresses the need in the art for efficiently allocating pick-up and drop-off locations (i.e. parking spaces).

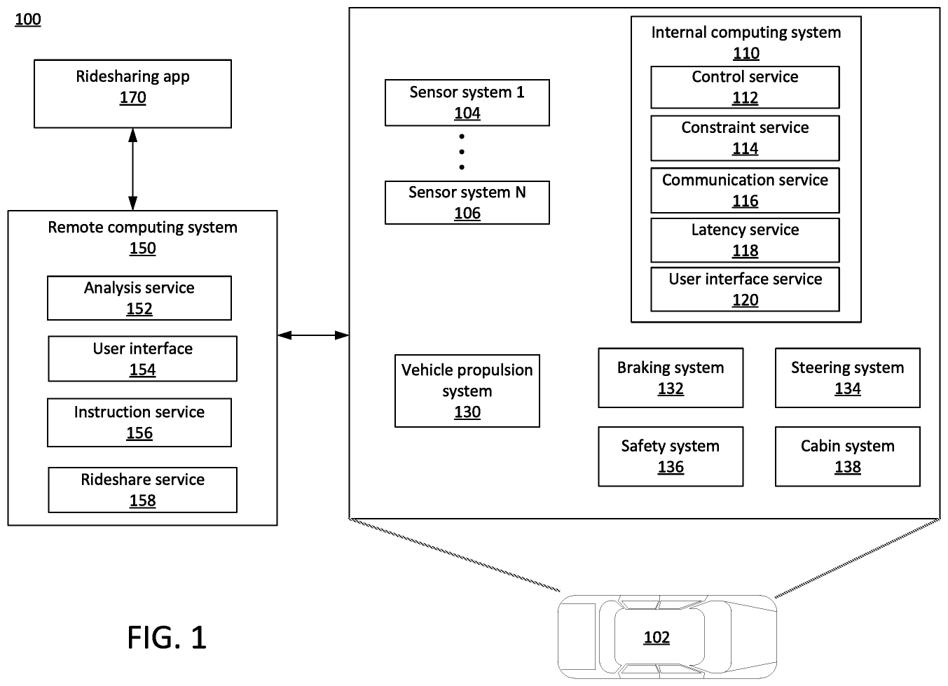

FIG. 1 illustrates environment 100 that includes an autonomous vehicle 102 in communication with a remote computing system 150.

The autonomous vehicle 102 can navigate about roadways without a human driver based upon sensor signals output by sensor systems 104-106 of the autonomous vehicle 102. The autonomous vehicle 102 includes a plurality of sensor systems 104-106 (a first sensor system 104 through an Nth sensor system 106). The sensor systems 104-106 are of different types and are arranged about the autonomous vehicle 102. For example, the first sensor system 104 may be a camera sensor system, and the Nth sensor system 106 may be a lidar sensor system. Other exemplary sensor systems include radar sensor systems, global positioning system (GPS) sensor systems, inertial measurement units (IMU), infrared sensor systems, laser sensor systems, sonar sensor systems, and the like.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 that is in communication with the sensor systems 104-106 and the systems 130, 132, 134, 136, and 138. The internal computing system includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 104-106 and human co-pilots, etc.

The internal computing system 110 can include a control service 112 that is configured to control the operation of the vehicle propulsion system 130, the braking system 108, the steering system 110, the safety system 136, and the cabin system 138. The control service 112 receives sensor signals from the sensor systems 104-106 as well communicates with other services of the internal computing system 110 to effectuate operation of the autonomous vehicle 102. In some embodiments, control service 112 may carry out operations in concert one or more other systems of autonomous vehicle 102.

The internal computing system 110 can also include a constraint service 114 to facilitate safe propulsion of the autonomous vehicle 102. The constraint service 116 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make necessary decisions or to provide the needed feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remote computing system 150 or a human operator via the remote computing system 150, software service updates, rideshare pickup and drop off instructions, etc.

The remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing application 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

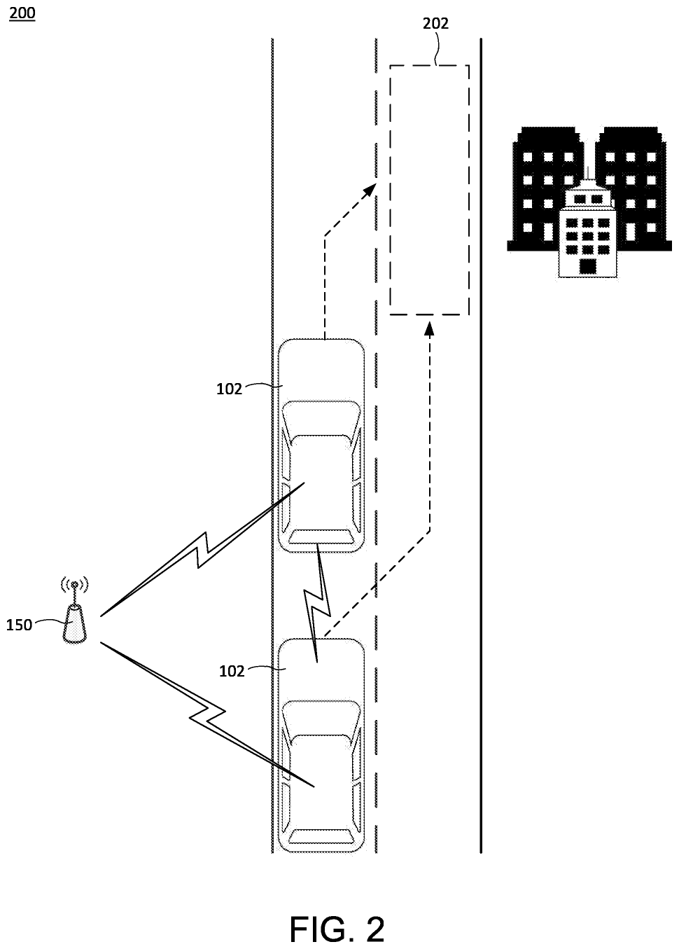

FIG. 2 shows an example environment 200 of autonomous vehicles 102 communicating for a pick-up or drop-off location 202. As shown, in some scenarios, there may be many autonomous vehicles 102 in a given area but only a limited number of pick-up or drop-off locations 202, such as a parking space 202. Thus, this could create a high degree of congestion in the area. By dynamically allocating the pick-up or drop-off locations 202 to autonomous vehicles 102, the autonomous vehicles 102 can minimize congestion by efficiently determining which autonomous vehicle 102 should occupy the pick-up or drop-off location 202 for a determined amount of time. In some embodiments, the autonomous vehicles 102 may communicate with the remote computing system 150, while in other embodiments, the autonomous vehicles 102 may communicate directly with each other. More specifically, the communications between the autonomous vehicles 102 and/or the remote computing system 150 may include bids for the pick-up or drop-off location 202, such that the autonomous vehicle 102 that submits the highest bid may occupy the pick-up or drop-off location 202.

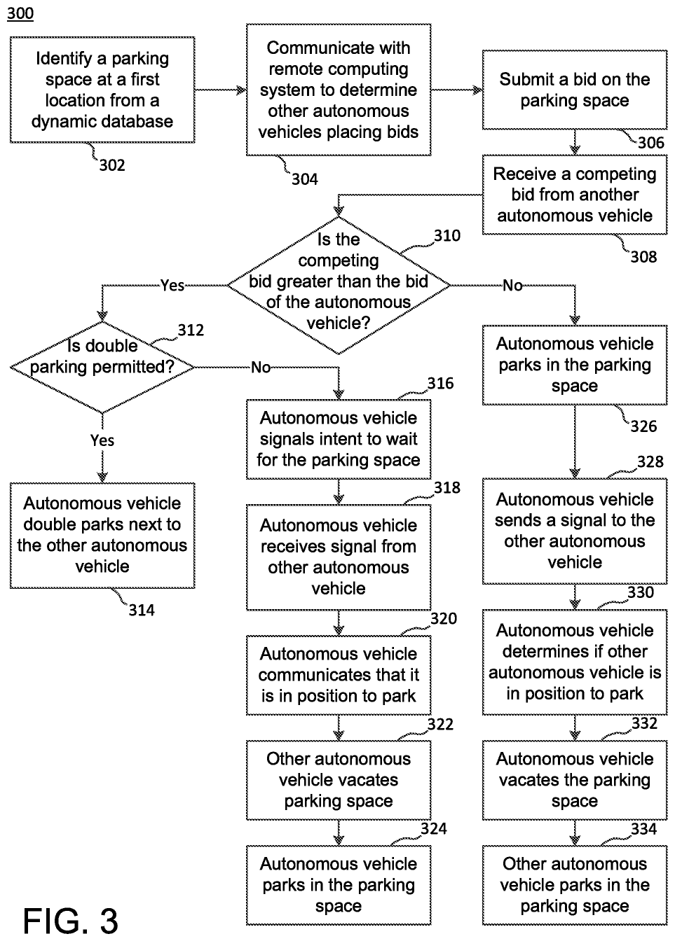

FIG. 3 is a flow diagram that illustrates a process 300 for dynamically allocating a pick-up or drop-off location 202.

The process 300 begins at step 302 when the autonomous vehicle 102 identifies a parking space 202 at a first location. The autonomous vehicle 102 may determine the parking space 202 from a dynamic database that may list available parking spaces in an area including the first location. In some embodiments, the identification of the parking space 202 at the first location may include an identification of multiple parking spaces 202. The first location may be a location to which the autonomous vehicle 102 has been dispatch or at which the autonomous vehicle 102 is to drop off a passenger or delivery.

In some embodiments, the autonomous vehicle 102 can determine the parking space 202 at some point prior to the autonomous vehicle 102 arriving at the first location. The autonomous vehicle 102 can be aware of available parking spots as other autonomous vehicles already at the first location detect available spots and report them to the dynamic database.

At step 304, the autonomous vehicle 102 may communicate with the remote computing system 150 to request and/or determine an identification of other autonomous vehicles that may bid for the parking space 202 at the first location. In some embodiments, it may not be necessary to request the identification of other autonomous vehicles that may bid for the parking space. In such embodiments, the autonomous vehicle 102 can utilize a function of a cellular network to transmit a message only to other autonomous vehicles in a particular cellular cell that covers the first location.

At step 306, the autonomous vehicle 102 may submit a bid to a bidding system for the parking space 202. The bidding system is configured to reserve the parking space 202 for the bid that is calculated to be the highest based on a common criteria shared by the autonomous vehicle 102 and other autonomous vehicles 102 bidding for the parking space 202 at the first location. In some embodiments, the submission of the bid by the autonomous vehicle 102 may include submitting individually determined bids on each of multiple parking spaces 202.

In some embodiments, the bidding system may be a consensus system, such that submission of the bid may be when the autonomous vehicle 102 sends bids directly to the other autonomous vehicles 102 bidding for the parking space 202 which respect the highest bid received. Similarly, the bid may be submitted when the autonomous vehicle 102 sends the bid directly to a plurality of autonomous vehicles in the area, a subset of which may include the other autonomous vehicles bidding for the parking space 202. In some embodiments, the bidding system may be directed and conducted by the remote computing system 150, which may be configured to receive bids and communicate instructions regarding allocation of the parking space to the autonomous vehicles 102.

The bidding system may be configured to calculate a quantified value for each bid. Each bid may include a wide variety of various factors including, but not limited to, estimated time to arrival, allowable buffers of time until arrival, detected and/or average speed of passenger entry and/or exit, proximity to next stop, autonomous vehicle's 102 need for servicing or maintenance, whether a passenger is waiting in the autonomous vehicle 102, number of passengers in the autonomous vehicle 102, passenger preferences, the usage of the autonomous vehicle 102 (e.g. delivering food or passenger ride), time of day, the location (e.g. a large business building will likely have many pick-up and/or drop-offs, whereas a passenger's home is likely to have less), surrounding traffic, number of bids submitted, etc. Furthermore, these factors may be valued differently based upon importance. In some embodiments, the bid may be a product of at least one factor value and an urgency weight. For example, in high traffic density areas, such as a large business district, there may be local statutes or rules that restrict vehicles in these zones to remain stationary for a short period of time. Thus, the bidding system may more heavily value a passenger's detected and/or average speed of entry and/or exit (i.e. a factor value) to abide by local statutes (i.e. an urgency weight). In other words, the example factor value described correlates to a factor selected from a normal duration passenger pick-up or drop-off and a long duration passenger pick-up or drop-off. In some scenarios, the factor may also be selected from a delivery or an urgent stop. For example, the autonomous vehicle 102 may be delivering food to customer, while another autonomous vehicle may have a passenger that is feeling carsick and needs to the autonomous vehicle 102 to pull over immediately.

At step 308, the autonomous vehicle 102 may receive a competing bid from one of the other autonomous vehicles 102 bidding on the parking space 202 at the first location. In embodiments having the bidding system conducted by the remote computing system 150, the remote computing system 150 may receive the competing bid from one of the other autonomous vehicles 102 bidding on the parking space 202.

At step 310, the bidding system determines whether the competing bid from the one of the other autonomous vehicles 102 is higher than the bid of the autonomous vehicle 102. The bidding system will determine, based upon the greatest of the bids, which of the autonomous vehicles 102 will be allocated the parking space 202. If the competing bid is higher than the bid of the autonomous vehicle 102, then the process 300 continues to step 312. If the competing bid is not greater than the bid of the autonomous vehicle 102, then the process 300 moves to step 326.

At step 312, the autonomous vehicle 102 has determined that the parking space 202 will not be allocated to the autonomous vehicle 102 because the competing bid is greater than the bid submitted by the autonomous vehicle 102. Thus, the autonomous vehicle 102 may determine whether the double parking next to the other autonomous vehicle is permitted and/or possible. For example, some city ordinances may allow for double parking, while others may not. Furthermore, when double parking is permitted, the space adjacent to the other autonomous vehicle may already be occupied or the congestion in the area makes double parking impractical and/or impossible.

If the autonomous vehicle 102 determines that double parking is permitted and/or possible, then the process 300 continues to step 314. At step 314, the autonomous vehicle 102 double parks next to the other autonomous vehicle.

If the autonomous vehicle 102 determines that double parking is not permitted and/or possible, then the process 300 moves to step 316. At step 316, the autonomous vehicle 102 may signal an intent to wait for the parking space 202. In other words, the autonomous vehicle 102 may wait until the other autonomous vehicle vacates the parking space 202. In some embodiments, the autonomous vehicle 102 may be configured to continue moving while waiting. For example, the autonomous vehicle 102 may begin process 300 again by circling the area and possibly identifying other parking spaces 202.

At step 318, the autonomous vehicle 102 receives a signal or communication from the other autonomous vehicle. The signal or communication may indicate or communicate that the other autonomous vehicle is ready to vacate the parking space 202.

At step 320, the autonomous vehicle 102 sends a return communication to the other autonomous vehicle that is currently occupying the parking space 202. The return communication may indicate that the autonomous vehicle 102 is in position to park in the parking space 202 after the other autonomous vehicle vacates the parking space 202.

At step 322, the other autonomous vehicle vacates the parking space 202.

At step 324, the autonomous vehicle 102 parks in the parking space 202.

Returning back to step 310, as discussed above, if the competing bid is not greater than the bid of the autonomous vehicle 102, then the process 300 moves to step 326. At step 326, the autonomous vehicle 102 has determined that the parking space 202 will be allocated to the autonomous vehicle 102. Thus, the autonomous vehicle 102 parks in the parking space 202. The autonomous vehicle 102 may also receive an intent from the other autonomous vehicle. As discussed above, the intent may communicate that the other autonomous vehicle 102 intends to wait for the autonomous vehicle 102 to vacate the parking space 202.

At step 328, the autonomous vehicle 102 sends a communication or signal to the other autonomous vehicle 102. As discussed above, the communication or signal may indicate or communicate that the autonomous vehicle 102 is ready to vacate the parking space 202.

At step 330, the autonomous vehicle 102 determines whether the other autonomous vehicle is in position to park in the parking space 202. As discussed above, this may be determined when the other autonomous vehicle sends a return communication indicating that the other autonomous vehicle is in position to park in the parking space 202. In some embodiments, the autonomous vehicle 102 may use the sensor systems 104-106 to determine whether the other autonomous vehicle is in position to park in the parking space 202.

At step 332, which occurs after the determining that the other autonomous vehicle is in position to park in the parking space 202, the autonomous vehicle 102 vacates the parking space 202.

At step 334, the other autonomous vehicle parks in the parking space 202.

In some embodiments, the bidding system may create queues to reserve parking spaces 202, such that there is minimal downtime between one autonomous vehicle 102 vacating the parking space 202 and another autonomous vehicle 102 parking in the parking space 202. In some embodiments, the bidding system may determine that establishing an efficient queue may require prioritizing or more favorably weighting a bid having a longer projected amount of stationary time in the parking space 202.

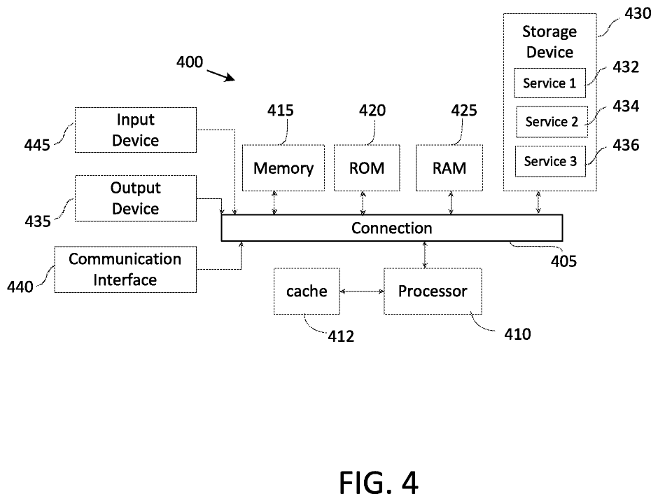

FIG. 4 shows an example of computing system 400, which can be for example any computing device making up internal computing system 110, remote computing system 150, (potential) passenger device executing rideshare app 170, or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement, and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A non-transitory computer readable medium comprising instructions that when executed causes at least one processor to:
identify, by an autonomous vehicle, a parking space at a first location from a dynamic database listing available parking spaces in an area including the first location; and
submit a bid on the parking space at the first location that if accepted by a bidding system, will reserve the parking space at the first location for the autonomous vehicle, wherein the bid is calculated using common criteria shared by the autonomous vehicle and other autonomous vehicles bidding for the parking space at the first location.

2. The non-transitory computer readable medium of claim 1, wherein the bid is a product of at least one factor value and an urgency weight.

3. The non-transitory computer readable medium of claim 2, wherein the at least one factor value correlates to a factor selected from a normal duration passenger pickup or drop off, a long duration passenger pickup or drop off, a delivery, or an urgent stop.

4. The non-transitory computer readable medium of claim 1, wherein the bidding system is a consensus system among the autonomous vehicle and the other autonomous vehicles bidding on the space, wherein the instructions further cause the at least one processor to:
prior to the submission of the bid, communicate with a server to request an identification of the other autonomous vehicles bidding for the space at the first location, wherein the submission of the bid comprises sending the bid directly to the other autonomous vehicles, whereby the highest bid is accepted.

5. The non-transitory computer readable medium of claim 1, wherein the bidding system is a consensus system among the autonomous vehicle and the other autonomous vehicles bidding on the space, wherein the bid is submitted when the autonomous vehicle sends a communication to a plurality of autonomous vehicles in the area, a subset of which includes the other autonomous vehicles bidding for the parking space.

6. The non-transitory computer readable medium of claim 1, wherein the identification of a parking space at a first location includes an identification of multiple parking spaces, and wherein the submission of the bid on the parking space includes submitting individually determined bids on each of the multiple parking spaces.

7. The non-transitory computer readable medium of claim 1, wherein the instructions further cause the at least one processor to:
receive a competing bid from one of the other autonomous vehicles bidding for the parking space at the first location, wherein the competing bid is greater than the bid submitted by the autonomous vehicle;
park, by the autonomous vehicle to double park, since the one of the other autonomous vehicles has a greater bid.

8. The non-transitory computer readable medium of claim 1, wherein the instructions further cause the at least one processor to:
receive a competing bid from one of the other autonomous vehicles bidding for the parking space at the first location, wherein the competing bid is greater than the bid submitted by the autonomous vehicle;
communicate an intent to wait for the parking space at the first location until after the one of the other autonomous vehicles has vacated the parking space;
receive a communication from the one of the other autonomous vehicles that it is ready to vacate the parking space.

9. The non-transitory computer readable medium of claim 1, wherein the instructions further cause the at least one processor to:
receive a competing bid from one of the other autonomous vehicles bidding for the parking space at the first location, wherein the competing bid is less than the bid submitted by the autonomous vehicle;
park in the parking space at the first location;
send a communication to the one of the other autonomous vehicles that the autonomous vehicle is ready to vacate the parking space;
determine that the one of the other autonomous vehicles is in position to park in the parking space; and
after the determination that the one of the other autonomous vehicles is in position to park in the parking space, vacate the parking space.

10. A method comprising:
identifying, by an autonomous vehicle, a parking space at a first location from a dynamic database listing available parking spaces in an area including the first location; and
submitting a bid on the parking space at the first location that if accepted by a bidding system, will reserve the parking space at the first location for the autonomous vehicle, wherein the bid is calculated using common criteria shared by the autonomous vehicle and other autonomous vehicles bidding for the parking space at the first location.

11. The method of claim 10, wherein the bid is a product of at least one factor value and an urgency weight.

12. The method of claim 11, wherein the at least one factor value correlates to a factor selected from a normal duration passenger pickup or drop off, a long duration passenger pickup or drop off, a delivery, or an urgent stop.

13. The method of claim 10, further comprising:
prior to the submission of the bid, communicating with a server to request an identification of the other autonomous vehicles bidding for the space at the first location, wherein the submission of the bid comprises sending the bid directly to the other autonomous vehicles, whereby the highest bid is accepted,
wherein the bidding system is a consensus system among the autonomous vehicle and the other autonomous vehicles bidding on the space.

14. The method of claim 10, wherein the bidding system is a consensus system among the autonomous vehicle and the other autonomous vehicles bidding on the space, wherein the bid is submitted when the autonomous vehicle sends a communication to a plurality of autonomous vehicles in the area, a subset of which includes the other autonomous vehicles bidding for the parking space.

15. The method of claim 10, wherein the identification of a parking space at a first location includes an identification of multiple parking spaces, and wherein the submission of the bid on the parking space includes submitting individually determined bids on each of the multiple parking spaces.

16. The method of claim 10, further comprising
receiving a competing bid from one of the other autonomous vehicles bidding for the parking space at the first location, wherein the competing bid is greater than the bid submitted by the autonomous vehicle;
parking, by the autonomous vehicle to double park, since the one of the other autonomous vehicles has a greater bid.

17. The method of claim 10, further comprising:
receiving a competing bid from one of the other autonomous vehicles bidding for the parking space at the first location, wherein the competing bid is greater than the bid submitted by the autonomous vehicle;
communicating an intent to wait for the parking space at the first location until after the one of the other autonomous vehicles has vacated the parking space;
receiving a communication from the one of the other autonomous vehicles that it is ready to vacate the parking space.

18. The method of claim 10, further comprising:
receiving a competing bid from one of the other autonomous vehicles bidding for the parking space at the first location, wherein the competing bid is less than the bid submitted by the autonomous vehicle;
parking in the parking space at the first location;
sending a communication to the one of the other autonomous vehicles that the autonomous vehicle is ready to vacate the parking space;
determining that the one of the other autonomous vehicles is in position to park in the parking space; and
after the determination that the one of the other autonomous vehicles is in position to park in the parking space, vacating the parking space.

19. An autonomous vehicle comprising:
a communication system; and
a computing system in communication with the communication system, the computing system comprising:
at least one processor; and
at least one memory storing computer-readable instructions thereon, the instructions are effective to cause the at least one processor to:
identify, by the autonomous vehicle, a parking space at a first location from a dynamic database listing available parking spaces in an area including the first location; and
submit a bid on the parking space at the first location that if accepted by a bidding system, will reserve the parking space at the first location for the autonomous vehicle, wherein the bid is calculated using common criteria shared by the autonomous vehicle and other autonomous vehicles bidding for the parking space at the first location.

20. The autonomous vehicle of claim 19, wherein the bid is a product of at least one factor value and an urgency weight.
